(19) United States
(12) Patent Application Publication
(10) Pub. No.: US 2008/0025182 A1
(43) Pub. Date: Jan. 31, 2008

(54) Method And Apparatus For Reproducing A Data Recorded In Recording Medium Using A Local Storage

(76) Inventors: Kang Soo Seo, Gyeonggi-do (KR); Byung Jin Kim, Gyeonggi-do (KR); Jea Yong Yoo, Songpa-gu (KR)

Correspondence Address: HARNESS, DICKEY & PIERCE, P.L.C., P.O. BOX 8910, RESTON, VA, 20195, US

(21) Appl. No.: 11/660,150

(22) PCT Filed: Sep. 13, 2005
(86) PCT No.: PCT/KR05/03017

§ 371 Date: Jun. 20, 2007

Related U.S. Application Data
(60) Provisional application No. 60/608,884, filed on Sep. 13, 2004.
(60) Provisional application No. 60/617,075, filed on Oct. 12, 2004.
(60) Provisional application No. 60/617,080, filed on Oct. 12, 2004.
(60) Provisional application No. 60/625,723, filed on Nov. 8, 2004.
(60) Provisional application No. 60/632,645, filed on Dec. 3, 2004.
(60) Provisional application No. 60/641,780, filed on Jan. 7, 2005.

(30) Foreign Application Priority Data
Dec. 9, 2004 (KR) 10-2004-0103551

(51) Int. Cl. G11B 3/64; G06F 7/00

(52) U.S. Cl. 369/85; 707/102

(57) ABSTRACT

A method and apparatus for reproducing data from a recording medium using a local storage is disclosed. The method for reproducing data of a recording medium using a local storage includes the steps of: a) reading a—binding unit contained in a directory associated with a recording medium from a file structure contained in the local storage/b) performing a binding operation for combining the read binding unit with the file structure contained in the recording medium, and forming a virtual package; and c) reproducing data stored in the recording medium and/or data stored in the local storage using the formed virtual package. Therefore, original data stored in the recording medium and additional data stored in the local storage can be effectively reproduced, resulting in greater convenience of use.

### TECHNICAL FIELD

The present invention relates to a method and apparatus for reproducing data from a recording medium, and more particularly to a method and apparatus for reproducing data from a recording medium using a local storage contained in an optical recording/reproducing device.

### BACKGROUND ART

Generally, there has been widely used an optical disc acting as a recording medium capable of recording a large amount of data therein. Particularly, there has recently been developed a high-density optical recording medium capable of recording/storing high-quality video data and high-quality audio data for a long period of time, for example, a Blu-ray Disc (BD).

The BD based on the next-generation recording medium technique has been considered to be the next-generation optical recording solution capable of storing much more data than a conventional DVD. In recent times, many developers have conducted intensive research into the international standard technical specification associated with the BD along with those of other digital devices.

In association with the above-mentioned situation, there has recently been developed an optical recording/reproducing device based on the BD international standard, but the BD international standard has not yet been completed, such that many limitations and problems occur in developing the optical recording/reproducing device.

Particularly, the above-mentioned optical recording/reproducing device must consider not only a basic function for recording/reproducing data of the BD, but also an additional function for enabling the optical recording/reproducing device to interact with peripheral digital devices. In other words, the optical recording/reproducing device must receive an external input signal, must display the received signal, and must reproduce desired data using the external input signal and the BD.

However, a method for reproducing data from the recording medium to simultaneously reproduce the external input signal and data of the BD has not yet been established, such that many limitations and problems occur in developing a BD-based optical recording/reproducing device.

### DISCLOSURE OF INVENTION

Accordingly, the present invention is directed to a method and apparatus for reproducing data from a recording medium using a local storage that substantially obviate one or more problems due to limitations and disadvantages of the related art.

An object of the present invention devised to solve the problem lies on a method and apparatus for reproducing data suitable for a recording medium.

Another object of the present invention devised to solve the problem lies on a playback system which includes a local storage capable of receiving/storing data from an external part, and simultaneously reproduces data stored in the local storage and data recorded in a recording medium, and a method for reproducing data from the recording medium.

A further object of the present invention devised to solve the problem lies on a method for forming a virtual file structure capable of reproducing data stored in the recording medium.

A further object of the present invention devised to solve the problem lies on a preferred file structure for storing data in the local storage.

The object of the present invention can be achieved by providing a method for reproducing data of a recording medium using a local storage comprising the steps of: a) reading a binding unit contained in a directory associated with a recording medium from a file structure contained in the local storage; b) performing a binding operation for combining the read binding unit with the file structure contained in the recording medium, and forming a virtual package; and c) reproducing data stored in the recording medium and/or data stored in the local storage using the formed virtual package.

In another aspect of the present invention, provided herein is a method for constructing a local storage file system comprising the steps of: a) allowing an org ID directory for each content provider to have at least one disc ID directory and a single shared directory; b) allowing each disc ID directory to have a first binding unit combined with only a corresponding recording medium (i.e., a disc); and c) allowing the single shared directory to have a second binding unit combined with all recording mediums (i.e., discs) provided from the content provider.

In a further aspect of the present invention, provided herein is a method for constructing a local storage file system comprising the steps of: a) allowing an org ID directory for each content provider to include at least one disc ID directory; and b) allowing the disc ID directory to include a first directory which has an active directory (Active) capable of constructing a current binding unit and an inactive directory (Inactive) incapable of the current binding unit.

In a further aspect of the present invention, provided herein is a method for forming a virtual package comprising the steps of: a) reading a file structure contained in a recording medium (i.e., a disc package) capable of reproducing original data recorded in the recording medium; b) reading a binding unit which is associated with the recording medium from a directory having the same identification (ID) information as that of the recording medium of a local storage file structure; and c) combining the read binding unit with the disc package, and forming a virtual package capable of reproducing original data contained in the recording medium and/or additional data contained in the local storage.

In a further aspect of the present invention, provided herein is a method for forming a virtual package comprising the steps of: a) reading an original file for reproducing original data contained in a recording medium, and reading an additional file contained in a local storage; b) if the original file has the same name as that of the additional file, replacing the original file with the additional file; and c) if the original file has a name different from that of the additional file, adding or appending the additional file, and forming the virtual package.

In a further aspect of the present invention, provided herein is an apparatus for reproducing data of a recording medium using a local storage comprising: a pickup unit for reading original data from a recording medium; a local storage for storing additional data associated with the original data, and including a file structure for managing the additional data, such that the file structure includes at least one directory for identifying individual recording mediums; and a controller for forming a virtual file system to simultaneously reproduce the original data and/or the additional data, and forming a virtual package capable of reproducing the original data and the additional data using the virtual file system.

### BRIEF DESCRIPTION OF DRAWINGS

The accompanying drawings, which are included to provide a further understanding of the invention, illustrate embodiments of the invention and together with the description serve to explain the principle of the invention.

In the drawings:

FIG. 1 is a conceptual diagram illustrating a method and apparatus for reproducing data from a recording medium according to the present invention;

FIG. 2 is a conceptual diagram illustrating a file structure recorded in an optical disc acting as a recording medium and a method for reproducing a specific title using the file structure;

FIG. 3 is a structural diagram illustrating a data record structure of an optical disc acting as a recording medium according to the present invention;

FIG. 4A is a block diagram illustrating an optical recording/reproducing device according to the present invention;

FIG. 4B is a block diagram illustrating an apparatus for reproducing data using a local storage from among overall components contained in the optical recording/reproducing device according to the present invention;

FIG. 5 is a conceptual diagram illustrating a method for forming a virtual file system capable of reproducing data recorded in a recording medium and data recorded in a local storage according to the present invention;

FIGS. 6A˜6G are conceptual file structures for use in a local storage file system in accordance with a variety of preferred embodiments of the present invention;

FIG. 7 is a conceptual diagram illustrating a method for forming a virtual package according to the present invention;

FIGS. 8A˜8C are conceptual file structures for use in a local storage file system in accordance with other preferred embodiments of the present invention;

FIGS. 9A˜9C are conceptual diagrams illustrating methods for forming another virtual package according to the present invention; and

FIGS. 10A˜10D are conceptual file structures for use in a local storage file system in accordance with still other preferred embodiments of the present invention.

### BEST MODE FOR CARRYING OUT THE INVENTION

Reference will now be made in detail to the preferred embodiments of the present invention, examples of which are illustrated in the accompanying drawings.

A method and apparatus for reproducing data from a recording medium using a local storage will hereinafter be described with reference to the annexed drawings.

Prior to describing the present invention, it should be noted that most terms disclosed in the present invention correspond to general terms well known in the art, but some terms have been selected by the applicant as necessary and will hereinafter be disclosed in the following description of the present invention. Therefore, it is preferable that the terms defined by the applicant be understood on the basis of their meanings in the present invention.

A recording medium for use in the present invention is indicative of all recordable mediums, for example, an optical disc, and a magnetic tape, etc., according to various recording schemes.

For the convenience of description and better understanding of the present invention, the optical disc, such as a BD, will hereinafter be exemplarily used as the above-mentioned recording medium in the present invention. It should be noted that technical ideas of the present invention can be applied to other recording mediums without departing from the scope and spirit of the invention.

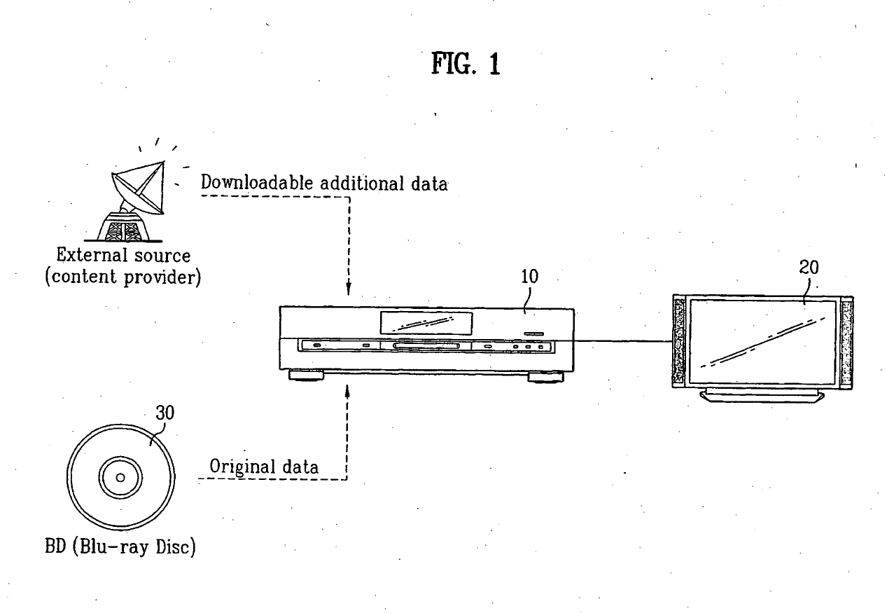

The term “local storage” is indicative of a storage unit contained in an optical recording/reproducing device 10 shown in FIG. 1. In more detail, the term “local storage” is indicative of a component capable of receiving necessary information or data from a user, and storing the received information or data. For example, a general local storage may be indicative of a Hard Disc Drive (HDD), but it should be noted that the term “local storage” of the present invention is not limited to the HDD, and is applicable to other examples as necessary.

Particularly, the term “local storage” is indicative of a storage unit for storing data associated with a recording medium such as a BD. The data associated with the recording medium is generally downloaded from an external device. In association with the above-mentioned description, it is obvious to those skilled in the art that the local storage may directly read some permission data from the recording medium, and may generate system data (e.g., metadata) associated with record/reproduction operations of the recording medium, such that the system data may be stored in the local storage.

The term “binding unit” is indicative of a set of files stored in the local storage. Particularly, the binding unit is indicative of a set of information (i.e., an information set) associated with a specific recording medium. In this case, the information set is replaced with or is added to file information contained in the specific recording medium, such that it can simultaneously reproduce data of the recording medium and data of the local storage. A detailed description of the binding unit will be given later.

For the convenience of description, data recorded in the recording medium is referred to as “original data”, data associated with the recording medium from among a plurality of data units stored in the local storage is referred to as “additional data”.

FIG. 1 is a conceptual diagram illustrating a method and apparatus for reproducing data according to the present invention. Unified usages of the optical recording/reproducing 10 and peripheral devices are shown in FIG. 1.

The optical recording/reproducing device 10 can record/reproduce data in/from various optical discs having different formats. If necessary, the optical recording/reproducing device 10 can record/reproduce specific data in/from only a specific optical disc such as a BD, or can reproduce the data from the optical disc without recording the data in the same. It should be noted that the present invention exemplarily uses a BD-player capable of reproducing data from the BD or a BD-recorder capable of recording data in the BD in consideration of correlation between the BD and peripheral devices for the convenience of description. It is well known in the art that the optical recording/reproduction device 10 is also applicable to a drive embedded in a specific device such as a computer.

The optical recording/reproducing device 10 records or reproduces data in/from the optical disc 30, receives an external input signal, performs a signal process on the received signal, and transmits the signal processed result to the external display 20, such that a user can view the signal processed result on the display 20. In this case, there is no limitation in a receivable external signal. For example, representative external input signals may be determined to be a DTV-associated signal and an Internet-associated signal, etc. Specifically, the Internet is indicative of a communication network to which a user easily gains access, such that the user can download specific Internet data using the optical recording/reproducing device 10, and can use the downloaded data.

In association with the above-mentioned description, an entity for providing content data used as an external source is generally referred to as a content provider (CP).

When original data is recorded in the optical disc 30 seated in the optical recording/reproducing device 10, and additional data associated with the original data is present in other storage locations (e.g., Internet), the present invention aims to reproduce the original data and, the additional data at the same time.

For example, it is assumed that multiplexed AV (Audio/Video) streams are recorded as the original data recorded in the optical disc, and additional data for use in the Internet is an audio stream different from an audio stream (e.g., Korean) of the original data. In this case, some users may download a specific audio stream (e.g., English) acting as additional data from the Internet, may desire to reproduce the downloaded audio stream along with the AV stream acting as original data, or may desire to reproduce only the additional data. In order to implement the above-mentioned desires of the users, correlation between the original data and the additional data must be established, and there is needed a systemized method for managing/reproducing the above-mentioned data according to a user request.

For the convenience of description, although a signal recorded in the disc is referred to as original data, and other signals existing in the outside of the disc are referred to as additional data, it should be noted that the original data and the additional data are not limited to any specific data.

Generally, additional data may be indicative of audio data, presentation graphic (PG) data, interactive graphic (IG) data, or text subtitle, etc., but the additional data may also be indicative of a multiplexed AV stream including the above-mentioned data and video data. In other words, data associated with the original data simultaneously existing in the local storage may act as additional data.

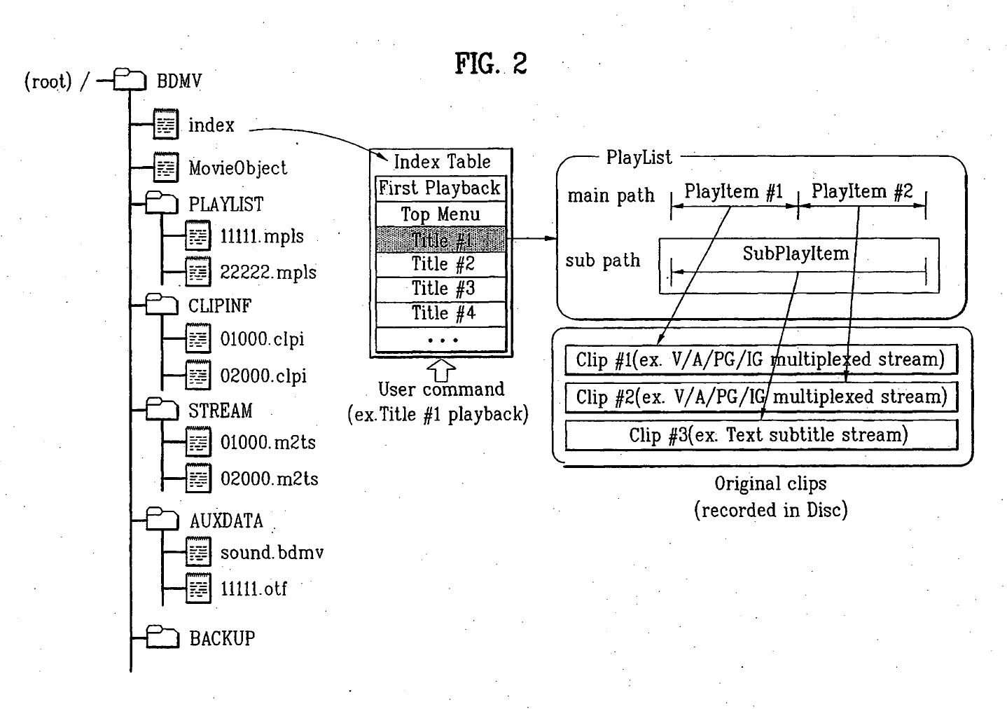

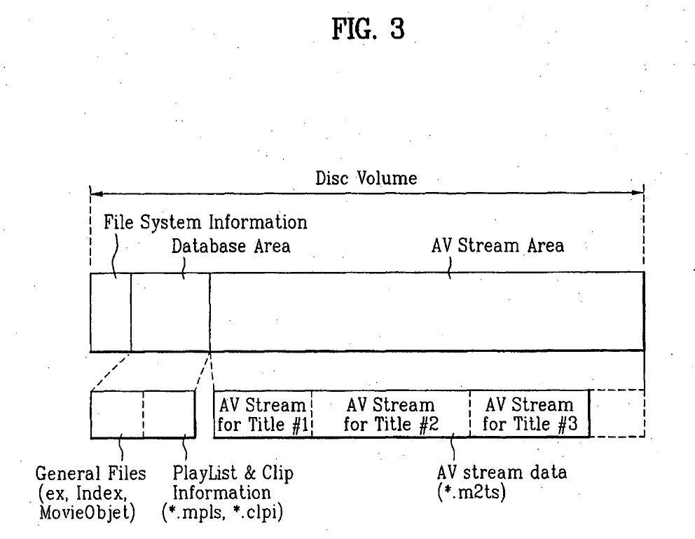

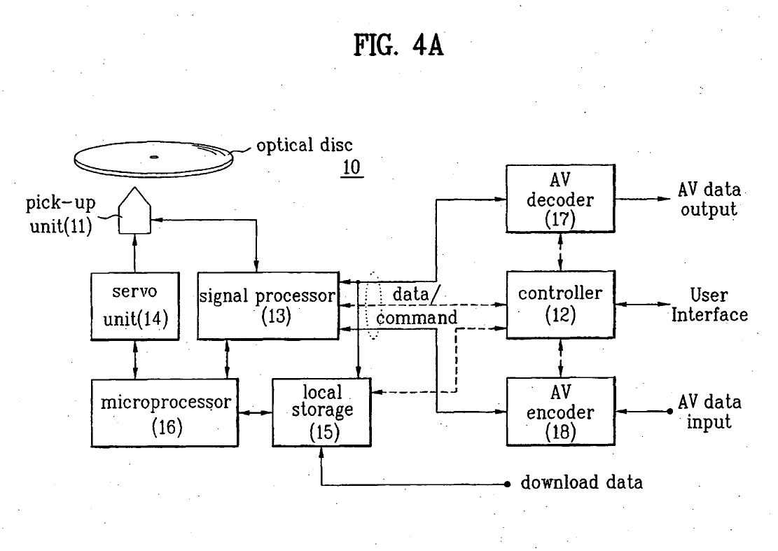

In order to satisfy the above-mentioned user requests, a predetermined file structure must be established between the original data and the additional data. Accordingly, a file structure and data record structure for use in the BD will hereinafter be described with reference to FIGS. 2-3.

FIG. 2 is a conceptual diagram illustrating a file structure for reproducing/managing the original data recorded in an optical disc, and a method for reproducing a specific title according to the file structure.

An example of the above-mentioned file structure is shown in FIG. 2. The file structure according to the present invention includes one or more BD directories (BDMV) under a single root directory. The BD directory (BDMV) includes not only an index file “index” acting as a general file (i.e., an upper file) capable of guaranteeing user interactivity, but also the above-mentioned object. The file structure includes a variety of directories for storing information of actual data recorded in a disc and other information associated with a method for reproducing the data, for example, a playlist directory (PLAYLIST), a clip information directory (CLIPINF), a stream directory (STREAM), an auxiliary directory (AUXDATA), and a backup directory (BACKUP). The above-mentioned directories and a variety of files included in the directory will hereinafter be described.

The AUXDATA directory includes an additional data file for reproducing data of the disc. For example, the AUXDATA directory includes a “Sound.bdmv” file for providing a user with sound data when an interactive graphic function is executed, and an “11111.otf” file for providing the user with font information when data of the disc is reproduced.

The stream directory (STREAM) includes a plurality of AV stream files recorded in a disc according to a specific format. Generally, individual streams are recorded using an MPEG-2 based transport packet, and the stream directory (STREAM) uses extension names of stream files (01000.m2ts and 02000.m2ts) as a specific extension name “*.m2ts”. Particularly, if video/audio/graphic information from among the above-mentioned streams is multiplexed, the multiplexed information is called an AV stream, and a single title is composed of at least one AV stream file.

The clip information (Clip-info) directory (CLIPINF) is composed of a plurality of clip-info files (01000.clpi and 02000.clpi) connected to the above-mentioned stream files on a one-to-one basis. Particularly, the clip-info files (*.clpi) record attribute information and timing information of the stream files (*.m2ts) therein. The clip-info files (*.clpi) connected to the stream files (*.m2ts) on a one-to-one basis are generically referred to as a “Clip”. In other words, this means that a single clip is indicative of data composed of a stream file (*.m2ts) and a clip-info file (*.clpi). A clip recorded in the disc is referred to as an original clip. A clip, which is downloaded and stored in a local storage, is referred to as an additional clip.

The playlist directory (PLAYLIST) includes a plurality of playlist files (*.mpls). Each playlist file (*.mpls) includes one or more playitems (PlayItem) and one or more sub-playitems (SubPlayItem). Each playitem (PlayItem) and each sub-playitem (SubPlayItem) are adapted to designate a playing interval during which a specific clip is reproduced. The playitem (PlayItem) and the subplayitem (SubPlayItem) include information associated with a specific clip to be reproduced, i.e., information associated with a reproduction start time (IN-Time) and other information associated with a reproduction termination time (OUT-Time) of the specific clip.

In association with the above-mentioned description, a process for reproducing data using at least one playitem (PlayItem) in the playlist file is referred to as a main path, and a process for reproducing data using individual sub-play items (SubPlayItem) is referred to as a sub-path. The playlist file must contain a single main path. The playlist file may contain at least one sub-path according to the presence or absence of the sub-playitem (SubPlayItem) as necessary.

In conclusion, the playlist file reproduces a desired clip by combination of one or more playitems (PlayItem).

The backup directory (BACKUP) stores a plurality of duplicate files, i.e., a duplicate file (also called “copied files”) of the index file “index” storing information associated with disc reproduction, a duplicate file of the object file “MovieObject”, duplicate files of all playlist files (*.mpls) contained in the playlist directory (PLAYLIST), and duplicate files of all clip-info files (*.clpi) contained in the clip-info directory (CLIPINF). If the above-mentioned files (“index”, “Movieobject”, “*.mpls”, and “*.clpi”) are damaged, a disc reproduction process is also fatally damaged, such that the backup directory (BACKUP) is designed to pre-store duplicate files of the above-mentioned files as backup files.

In association with the above-mentioned description, a method for reproducing a specific title using the above-mentioned disc file structure is shown in FIG. 2.

If a user enters a title reproduction command in association with a title used as an index file (also called “index table”), reproduction of the title begins. A detailed description thereof will hereinafter be described.

The index file (index.bdmv) includes first playback information “First Playback” indicative of information associated with a first reproduction image when data of a corresponding disc is loaded, top menu information “Top Menu” for providing a menu image, and at least one title information “Title #1˜Title #n”.

If the disc 30 is loaded in the optical recording/reproducing device 10, title menu information associated with the index table is provided to the user via the display 20. If the user selects a specific title or a specific menu contained in a menu image, data reproduction begins according to a scenario pre-defined by a disc manufacturer. In other words, if the user enters a command for reproducing a specific title (e.g., title #1), a specific playlist file is executed according to a command contained in the object file (MovieObject) of the reproduction/management file structure. Thereafter, one or more clips (e.g., Clip #1-Clip #3) constructing the title #1 are reproduced by a specific playitem and/or subplayitem contained in the playlist file according to the playlist file information.

FIG. 3 is a structural diagram illustrating a data record structure recorded in a recording medium according to the present invention. In more detail, FIG. 3 shows a disc record format of information associated with the file structure. As shown in FIG. 3, from the viewpoint of an inner area of the disc, the above-mentioned disc structure sequentially includes a file system information area serving as system information for managing overall files, a database area for recording a playlist file and a clip-info file to reproduce a recorded AV stream (*.m2ts), and an AV stream area for recording a plurality of streams composed of audio data, video data, and graphic data, etc. Particularly, it should be noted that data recorded in the AV stream area may be determined to be original data as previously stated above.

The present invention provides a method and apparatus for simultaneously reproducing original data (e.g., a file structure shown in FIG. 2) recorded in the disc and additional data recorded in the local storage, and a variety of preferred embodiments according to the present invention will hereinafter be described.

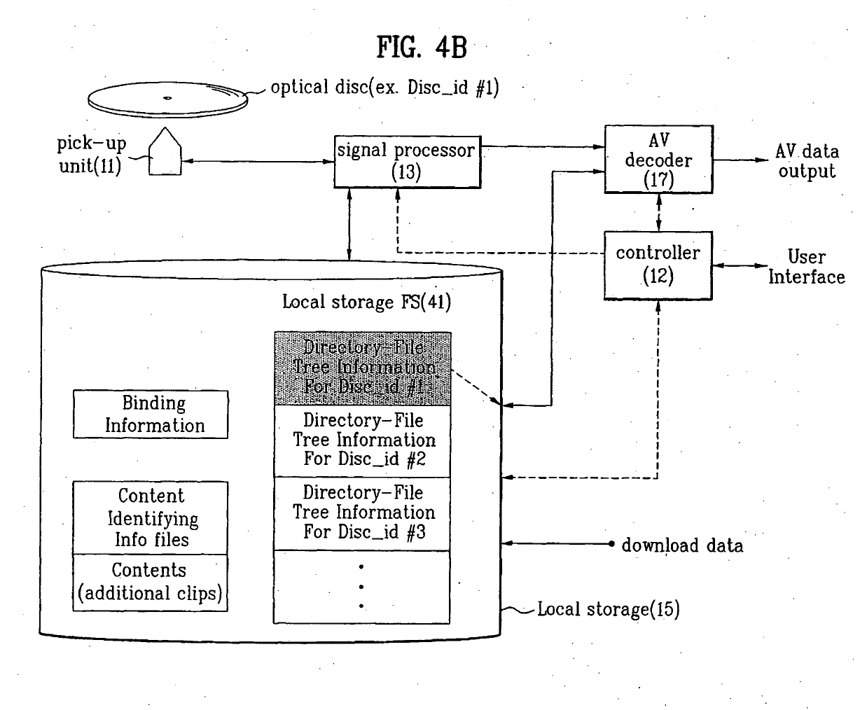

FIG. 4A is a block diagram illustrating the optical recording/reproducing device 10 according to the present invention.

Referring to FIG. 4A, the optical recording/reproducing device 10 includes a pickup unit 11, a servo unit 14, a signal processor 13, and a microprocessor 16. The pickup unit 11 reads original data recorded in the optical disc and management information including reproduction/management file information. The servo unit 14 controls operations of the pickup unit 11. The signal processor 13 receives a reproduction signal from the pickup unit 11, restores the received reproduction signal to a desired signal value, or modulates a signal to be recorded into another signal recorded in the optical disc, such that it transmits the restored or modulated result. The microprocessor 16 controls mutual operations of the above-mentioned components.

A controller 12 downloads additional data from outside of the optical disc upon receiving a command from a user, stores the downloaded additional data in the local storage 15, and configures a virtual file system (VFS) to reproduce the original data recorded in the optical disc and the additional data stored in the local storage. The controller 12 forms a virtual file structure (hereinafter referred to as a virtual package) including the original data and associated additional data using, the VFS, and reproduces the original data and/or the additional data using the formed virtual package upon receiving a request from a user.

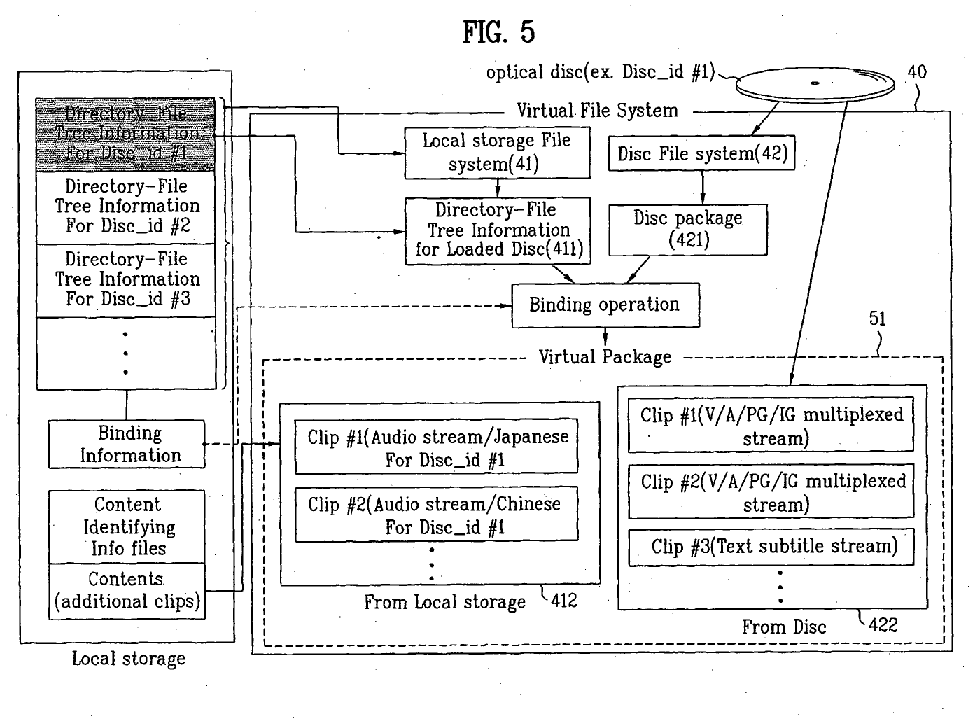

In association with the above-mentioned description, a detailed description of the VFS and the virtual package will hereinafter be described with reference to drawings from FIG. 5.

A decoder 17 finally decodes output data (i.e., original data and/or additional data) upon receiving a control signal from the controller 12, and provides the user with the decoded result.

An encoder 18 converts an input signal into a specific format signal (e.g., an MPEG2 transport stream) upon receiving a control signal from the controller 12, and transmits the converted result to the signal processor 13.

The new virtual package may be stored in the local storage 15 such that it can be re-used in the future. Also, the new virtual package may be temporarily stored in an additional dynamic memory, and may then be used.

FIG. 4B is a block diagram illustrating an apparatus for reproducing data of an optical disc using a local storage from among overall components contained in the optical recording/reproducing device 10 according to the present invention.

Information stored in the local storage 15 will hereinafter be described. The local storage 15 according to the present invention stores file information (Directory-File Tree Information for Disc_id #n) including directories and files of individual disc identification (ID) information, and a plurality of additional clips downloaded from an external part. The local storage 15 may further store binding information for a binding operation associated with a disc package, and a plurality of files (Content Identifying Info files) for explaining content data stored in the local storage 15.

Specifically, the local storage 15 may include a plurality of file information units (Directory-File Tree Information for Disc_id #n) to cope with different discs. Therefore, the local storage 15 additionally requires a file system for managing the above-mentioned file information units. Specifically, the file system is also referred to as a local storage file system 41, and the local storage file system 41 is indicative of a system for managing all files stored in the local storage 15.

Therefore, if an optical disc (e.g., Disc_id #1) of a specific disc ID (Disc_id) is loaded in the optical recording/reproducing device 10, the controller 12 contained in the optical recording/reproducing device 10 recognizes ID information of the disc using the pickup unit 11 and the signal processor 13, reads file information equal to the loaded disc ID information from among all file information units stored in the local storage 15, forms a virtual package by binding (or combining) the read information and the disc package, and reproduces both the original data of the disc and the additional data of the local storage using the formed virtual package.

A preferred embodiment for generating the virtual package according to the present invention will hereinafter be described.

FIG. 5 is a conceptual diagram illustrating a method for forming the above-mentioned virtual file system (i.e., the virtual package) according to the present invention.

If a specific disc is loaded in the optical recording/reproducing device 10 on the condition that the information and content shown in FIG. 4B are stored in the local storage 15, the optical recording/reproducing device 10 reads the file system information 41 contained in the local storage 15, and at the same time reads disc file system information 42 including the file structure recorded in the disc, resulting in the creation of the VFS. In more detail, the virtual file system (VFS) is indicative of a file system virtually formed to manage both the file system contained in the local storage 15 and the other file system of the loaded disc.

The optical recording/reproducing device forms a new virtual package to simultaneously reproduce original data recorded in the disc and additional data recorded in the local storage using the above-mentioned virtual file system (VFS). For this purpose, the optical recording/reproducing device 10 reads file information (Directory-File Tree Information for Disc_id #n) associated with the disc (e.g., Disc_id #1) from the file system, and performs a binding operation for replacing the read file information with a disc package of the loaded disc (Disc_id #1) or adding the read file information to the disc package.

The virtual package formed by the above-mentioned binding operation is indicative of a file structure for reproducing/managing an original clip 422 and an additional clip 412. The original clip 422 is composed of original data recorded in the disc. The additional clip 412 is composed of additional data recorded in the local storage.

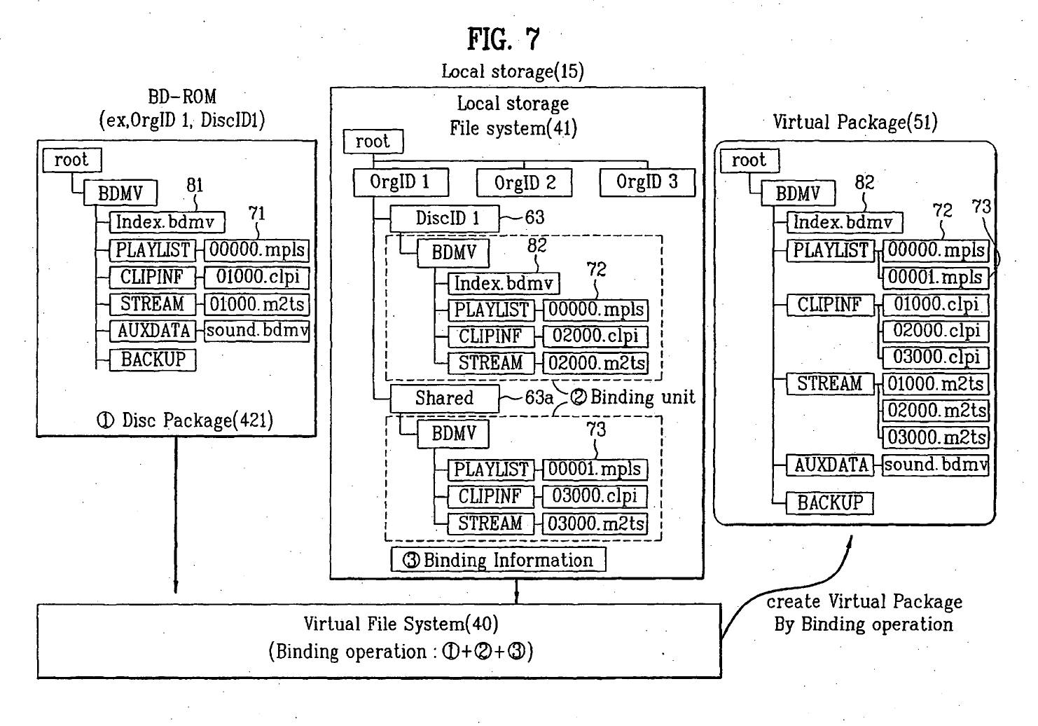

In association with the above-mentioned description, the new virtual package has the same directory structure as that of a disc package 42, and a detailed description thereof will be given with reference to FIG. 7.

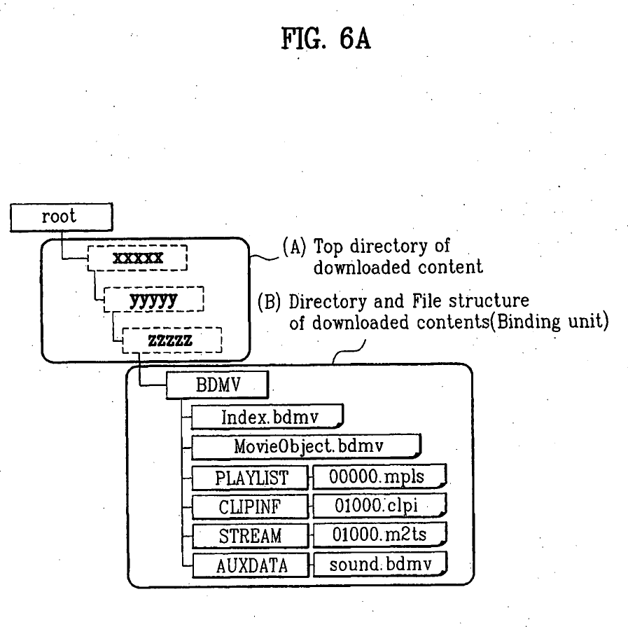

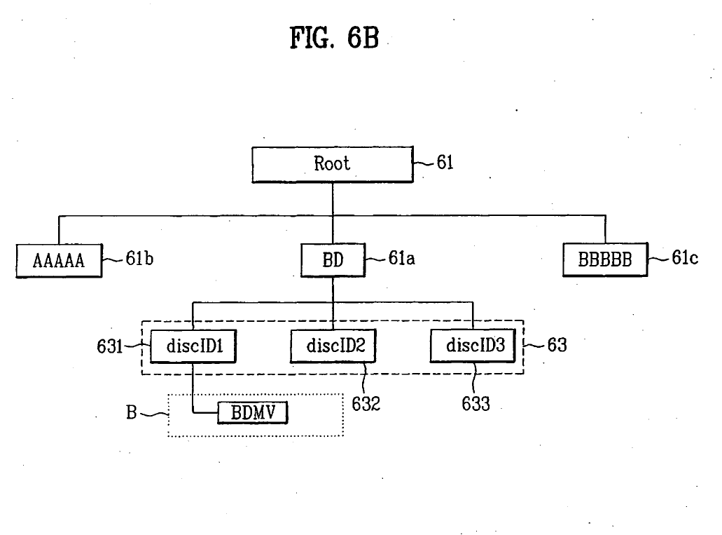

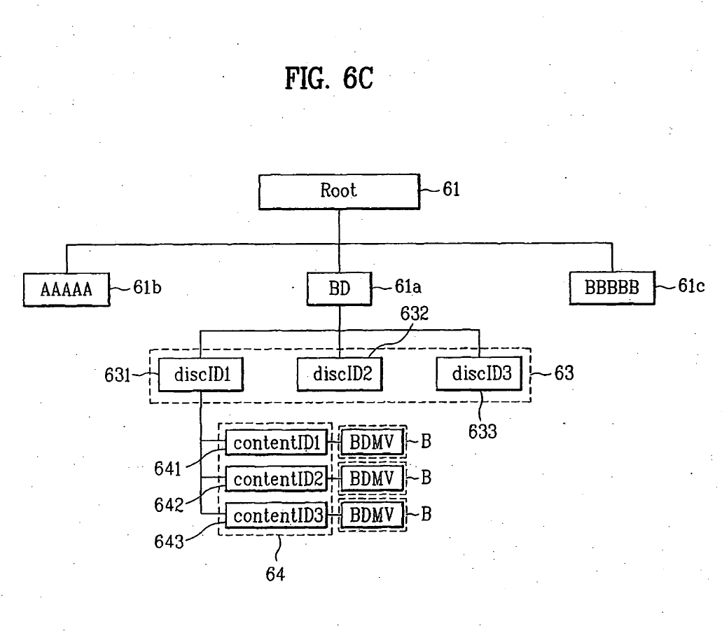

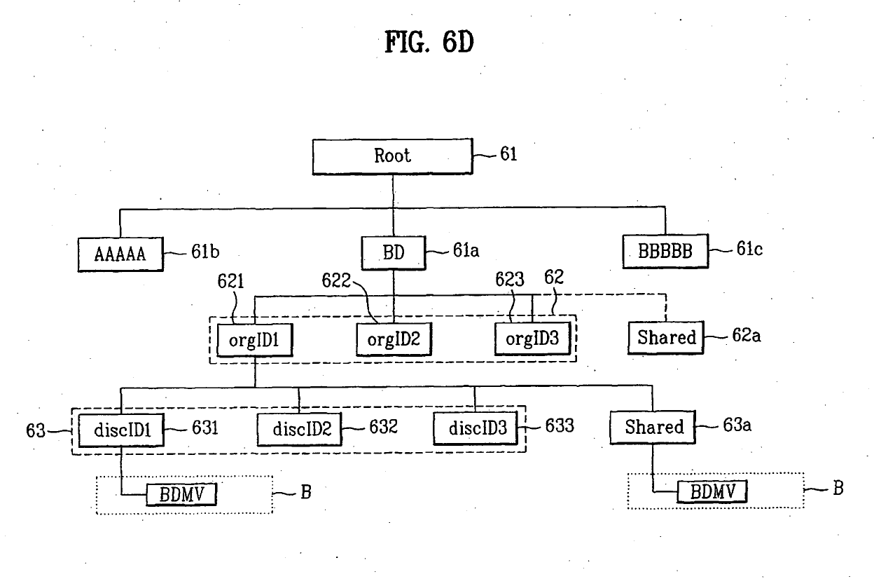

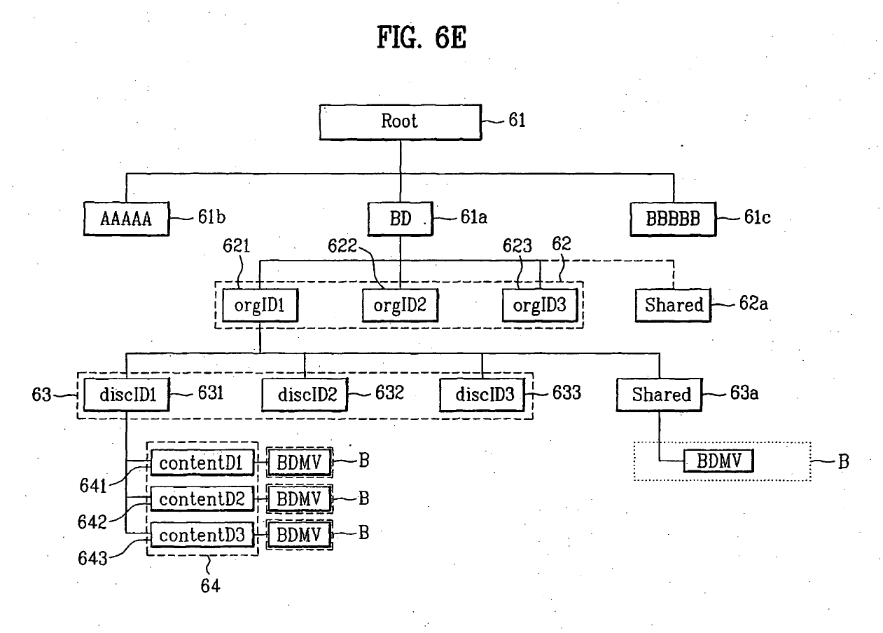

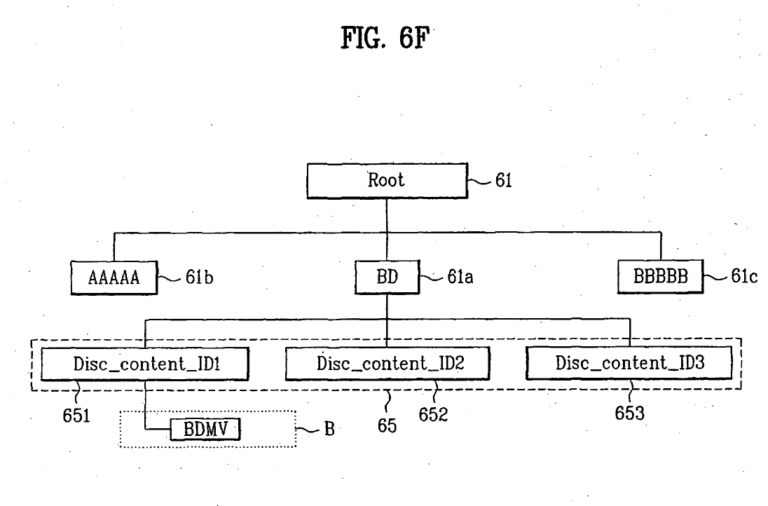

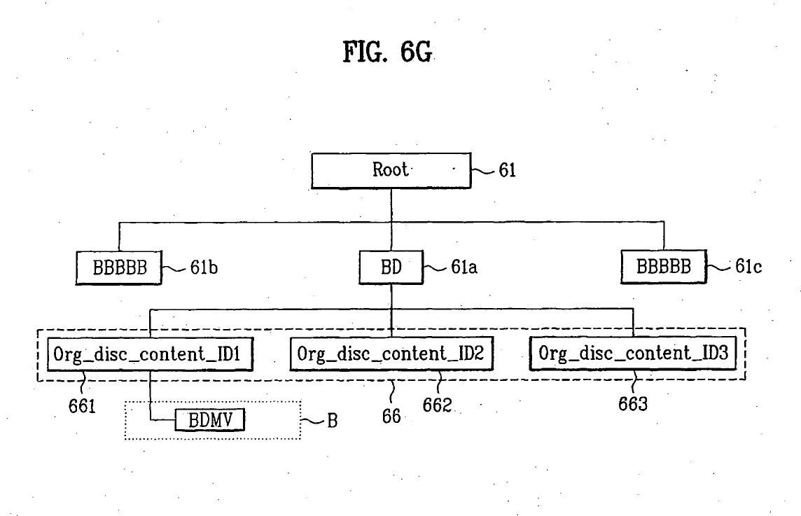

FIGS. 6A˜6G are conceptual file structures for use in a local storage file system in accordance with a variety of preferred embodiments of the present invention. In more detail, a variety of examples of a file structure associated with a file system contained in the local storage 15 (i.e., a local storage file system) are shown in FIGS. 6A˜6G.

FIG. 6a is a conceptual file structure of a local storage file system 41 according to the present invention.

Referring to FIG. 6A, the local storage file system 41 includes a “Directory and File structure” (B) for managing downloaded additional data, and a “Top Directory Structure” (A) for identifying a specific disc combined with the downloaded additional data. The “Top Directory Structure” (A) is referred to as a “Top Directory”. The “Directory and File structure” (B) is referred to as a “Binding Unit”.

In association with the above-mentioned description, the binding unit has the same structure as the disc package (i.e., the disc file structure) shown in FIG. 2. The binding unit includes an index file, an object file, a playlist directory (PLAYLIST), a clip-info directory (CLIPINF), a stream directory (STREAM), and an auxiliary directory (AUXDATA). The above-mentioned directories (PLAYLIST, CLIPINF, STREAM, and AUXDATA) includes unique files.

The binding unit is associated with a specific case in which there are all downloaded additional data. If only some files are downloaded, it is obvious to those skilled in the art that only a directory and a file associated with the downloaded files are present in the binding unit.

For example, if a playlist file (*.mpls) and clips (*.clpi, *.m2ts) are downloaded only, the binding unit may include only the playlist directory (PLAYLIST), the clip-info directory (CLIPINF), and the stream directory (STREAM) to manage the downloaded playlist files (*.mpls) and the downloaded clips (*.clpi, *.m2ts) as necessary.

The “Top Directory” (A) structure includes at least one directory structure (A) for identifying a specific disc with which the downloaded additional data must be combined. A variety of preferred embodiments of the above-mentioned “Top directory” (A) structure will hereinafter be described with reference to FIGS. 6B˜6G.

FIG. 6B is a conceptual file structure for use in a local storage file system 41 in accordance with a preferred embodiment of the present invention. Specifically, the local storage file system 41 of FIG. 6B is shown on the basis of the “Top Directory” (A).

Referring to FIG. 6B, a BD directory 61a for identifying the downloaded additional data associated with a specific disc (e.g., a BD), and other directories (i.e., an AAAAA directory 61b and/or a BBBBB directory 61c) for managing general application data are positioned under a root directory 61 of the local storage file system 41.

In association with the above-mentioned description, detailed structures of the AAAAA directory 61b and/or the BBBBB directory 61c are not directly associated with the present invention, so that their detailed descriptions will herein be omitted for the convenience of the description.

In association with the above-mentioned description, at least one disc ID (discID) directory 63 for identifying type information of a specific disc is positioned under the BD directory 61a. Individual discs having different types include at least one disc ID directory 63. Each disc ID directory BD includes the above-mentioned binding unit B.

For example, FIG. 6B shows an exemplary case in which the local storage file system 41 includes only the disc ID (discID) directory 63 as a disc ID directory capable of identifying a specific disc combined with each downloaded additional data.

Therefore, if a specific disc is loaded in the optical recording/reproducing device, the binding unit B contained in the same directory as that of corresponding disc ID (e.g., “Disc_id”) information is combined with the loaded disc file structure, such that the above-mentioned virtual package is formed.

FIG. 6C is a conceptual file structure for use in a local storage file system 41 in accordance with another preferred embodiment of the present invention. Specifically, the local storage file system 41 of FIG. 6C is shown on the basis of the “Top Directory” (A).

In association with the above-mentioned description, the file structure of FIG. 6C is the same as that of FIG. 6B. However, the local storage file system of FIG. 6C further includes a content ID (contentID) directory 64 for each content data, differently from the local storage file system of FIG. 6B.

For example, in association with the above-mentioned content ID (contentID) directories 641, 642, and 643, a single content ID directory 641, 642, or 643 is formed whenever specific content data associated with the disc ID (discID) directory 631 is downloaded.

Therefore, a disc ID directory 63 for identifying type information of a specific disc and a content ID directory 64 for identifying content data are hierarchically positioned under the BD directory 61a. The above-mentioned binding unit B is contained in each content ID directory 64.

FIG. 6D is a conceptual file structure for use in a local storage file system 41 in accordance with another preferred embodiment of the present invention. Specifically, the local storage file system 41 of FIG. 6D is shown on the basis of the “Top Directory” (A).

Referring to FIG. 6D, a BD directory 61a for identifying the downloaded additional data associated with a specific disc (e.g., a BD), and other directories (i.e., an AAAAA directory 61b and/or a BBBBB directory 61c) for managing general application data are positioned under a root directory 61 of the local storage file system 41.

In association with the above-mentioned description, an org ID directory 62 for identifying a content provider (CP) and a disc ID directory 63 for identifying type information of a specific disc are positioned under the BD directory 61a. The above-mentioned binding unit B is contained in each disc ID directory 63.

The org ID directory 62 includes one or more directories classified according to content providers (CPs) for providing the above-mentioned additional data. Generally, the directories contained in the org ID directory 62 are classified according to title producers (also called “studios”) for manufacturing movie titles. For example, the org ID_{—}1 directory 621 is indicative of an A studio, the org ID_{—}2 directory 622 is indicative of a B studio, and the org ID_{—}3 directory 623 is indicative of a C studio. One or more disc ID directory 63 classified according to disc types manufactured by individual studios are positioned under each of the org ID directories 621, 622, and 623. For example, the title #1 from among individual titles #1˜#3 manufactured by the A studio denoted by the org ID_{—}1 directory 621 is denoted by the disc ID_{—}1 directory 631, the title #2 is denoted by the disc ID_{—}2 directory 632, and the title #3 is denoted by the disc ID_{—}3 directory 633. The above-mentioned binding unit is contained in each of the disc ID directories 631, 632, and 633.

According to the preferred embodiment shown in FIG. 6D, the org ID directory 62 and the disc ID directory 63, which act as ID directories for identifying a specific disc combined with individual downloaded additional data, are hierarchically contained in the local storage file system 41. Therefore, if a specific disc is loaded in the optical recording/reproducing device, the binding unit B contained in the same directory as ID information (e.g., “Org_ID & Disc_id”) of the loaded disc is combined with the loaded disc package, such that the above-mentioned virtual package is formed.

In association with the above-mentioned description, the local storage file system 41 of FIG. 6D further includes a first shared (Shared) directory 62a commonly applied to all content providers (CPs), and a second shared (Shared) directory 63a commonly applied to all disc ID directories 63 of individual CPs. In this case, the first shared directory 62a and the second shared directory 63a are positioned under the BD directory 61a.

The first shared directory 62a aims to provide general data commonly applied to all studios. Preferably, assuming that all studios (i.e., CPs) agree with the necessity of the above-mentioned first shared directory 62a, the local storage file system 41 of FIG. 6D may include the first shared directory 62a. In order to designate the above-mentioned fact, a dotted line is connected to the first shared directory 62a.

In the meantime, the second shared directory 63a aims to provide general data commonly applied to all titles (e.g., disc ID directories 631˜633 contained in the org ID directory 621) of individual studios.

For example, the second shared directory 63a is adapted to apply the same initial screen to titles manufactured by a corresponding studio, or is used as a directory for providing a specific screen image for advertising new titles of the corresponding studio. In other words, although there is no agreement between all studios, the second shared directory 63a may be contained in the file structure as necessary, differently from the first shared directory 62a.

Therefore, if there are the first shared directory 62a and/or the second shared directory 63a, the binding unit B contained in a corresponding shared directory is combined with the disc package, and a detailed description thereof will be described later with reference to FIG. 7.

FIG. 6E is a conceptual file structure for use in a local storage file system 41 in accordance with another preferred embodiment of the present invention. Specifically, the local storage file system 41 of FIG. 6E is shown on the basis of the “Top Directory” (A).

In association with the above-mentioned description, the file structure of FIG. 6E is the same as that of FIG. 6D. However, the local storage file system of FIG. 6E further includes a content ID (contentID) directory 64 for each downloaded content data unit, differently from the local storage file system of FIG. 6D. The content ID directory 64 is positioned under the disc ID directory 63.

For example, in association with the above-mentioned content ID (contentID) directories 641, 642, and 643, a single content ID directory 641, 642, or 643 is formed whenever specific content data associated with the disc ID (discID) directory 631 is downloaded.

Therefore, an org ID directory 62 for identifying a content provider (CP), a disc ID directory 63 for identifying type information of a specific disc, and a content ID directory 64 for identifying content data are positioned under the BD directory 61a. The above-mentioned binding unit B is contained in each content ID directory 64.

The local storage file system of FIG. 6E may further include the first shared directory 62a and/or the second shared directory 63a in the same manner as in FIG. 6D.

FIG. 6F is a conceptual file structure for use in a local storage file system 41 in accordance with another preferred embodiment of the present invention. Specifically, the local storage file system 41 of FIG. 6F is shown on the basis of the “Top Directory” (A).

In association with the above-mentioned description, the local storage file system of FIG. 6F is characterized in that it includes a single directory for identifying a specific disc. For example, the disc ID directory 63 and the content ID directory 64 shown in FIG. 6C are unified such that a disc content ID (disc_content_ID) directory 65 is formed.

In more detail, in association with the disc content ID (disc_content_ID) directories 651, 652, and 653, a single disc content ID directory 651, 652, or 653 is formed whenever specific content data associated with a specific disc is downloaded.

Therefore, only the disc content ID (disc_content_ID) directory 65 for identifying specific disc type information and content type information is positioned under the BD directory 61a. The above-mentioned binding unit B is contained in individual disc content ID (disc_content_ID) directories 651, 652, and 653.

FIG. 6G is a conceptual file structure for use in a local storage file system 41 in accordance with another preferred embodiment of the present invention. Specifically, the local storage file system 41 of FIG. 6G is shown on the basis of the “Top Directory” (A).

In association with the above-mentioned description, the local storage file system of FIG. 6G is characterized in that it includes a single directory for identifying a specific disc. For example, the org ID (orgID) directory 62, the disc ID directory 63, and the content ID directory 64 shown in FIG. 6E are unified such that an org disc content ID (org_disc_content_ID) directory 66 is formed.

In more detail, in association with the org disc content ID (org_disc_content_ID) directories 661, 662, and 663, a single org disc content ID directory 661, 662, or 663 is formed whenever specific content data associated with a specific disc is downloaded.

Therefore, only the org disc content ID (org_disc_content_ID) directory 66 for identifying type information of a specific studio, disc, and content data is positioned under the BD directory 61a. The above-mentioned binding unit B is contained in individual org disc content ID (org_disc_content_ID) directories 661, 662, and 663.

In association with the above-mentioned preferred embodiments associated with the local storage file system 41 according to the present invention, at least one ID directory is contained in the remaining preferred embodiments other than the preferred embodiment of FIG. 6E. Therefore, it may be desirable that directories not contained in the remaining preferred embodiments other than the preferred embodiment of FIG. 6E are configured in the form of metadata indicative of system data, and are then additionally stored.

For example, the preferred embodiment of FIG. 6B does not include the org ID directory 62 and the content ID directory 64. Preferably, CP- and content-information may be configured in the form of metadata, and may then be managed. The content ID directory is not present in the preferred embodiment of FIG. 6D, such that information associated with content may be configured in the form of metadata, and may then be managed.

FIG. 7 is a conceptual diagram illustrating a method for forming a virtual package using the virtual file system (VFS) on the basis of a file structure according to the present invention.

Referring to FIG. 7, a specific file structure (i.e., the disc package of FIG. 2) is recorded in the loaded disc. A local storage file system 41 including one of the disc packages of FIGS. 6B-6G is contained in the local storage.

The local storage file system 41 includes a binding unit and binding information, which are combined with the loaded disc (e.g., Disc_id #1).

In association with the above-mentioned description, the present invention exemplarily shows the following case in which the disc package of the local storage file system 41 includes the disc ID directory 63 and the second shared directory 63a under the org ID directory 62 according to the preferred embodiment of FIG. 6D.

As can be seen from FIG. 7, each of the disc ID directory 63 and the second shared directory 63a includes a binding unit [symbol] combined with the loaded disc (e.g., OrgID 1 & DiscID_1).

The local storage file system 41 includes binding information [symbol] . The binding information [symbol] includes various information associated with the binding unit [symbol] , for example, file types of the binding unit, update times of the binding unit, and a binding method, etc. However, a predetermined binding method may be applied to some examples as necessary. In other words, the predetermined binding method may also be applied to some examples even though there is no binding information.

In association with the above-mentioned description, the binding unit [symbol] is basically similar to the disc package. Specifically, the binding unit may include a playlist file having the same name as that of a specific playlist file contained in the disc, such that it can be combined with the specific playlist file. However, the binding unit cannot act as a reproduction/management file alone, and this fact is considered to be a difference between the binding unit [symbol] and the disc package [symbol] .

It should be noted that the binding unit [symbol] cannot be operated as a reproduction/management file by itself, differently from the disc package [symbol] . If it is assumed that the binding unit [symbol] is designed to perform data reproduction by itself, this data reproduction is similar to data reproduction of the local storage, such that the above-mentioned operations of the binding unit are contrary to the purpose of the present invention for simultaneously reproducing both original data recorded in the disc and additional data recorded in the local storage.

Therefore, the virtual file system (VFS) performs a binding operation for combining the binding unit [symbol] with the disc package [symbol] of the loaded disc using the above-mentioned binding information [symbol] , such that it forms a new virtual package 51.

In association with the above-mentioned description, various features of the above-mentioned binding operation, and the virtual package formed by the binding operation will hereinafter be described.

The first feature of the binding operation is as follows. If names of files contained in the disc package [symbol] are equal to those of files contained in the binding unit [symbol] , files contained in the virtual package 51 are replaced with the aforementioned files contained in the binding unit [symbol] . For example, as shown in FIG. 7, the index file (index.bdmv) 82 and the playlist file (00000.mpls) 72, which have the same file names as the index file (index.bdmv) 81 and the playlist file (00000.mpls) 71 contained in the disc package [symbol] , are present in the binding unit [symbol] , the index file (index.bdmv) 82 and the playlist file (00000.mpls) 72 are replaced with files contained in the binding unit [symbol] of the new virtual package.

An external content provider (CP) capable of providing the index file (index.bdmv) 82 and the playlist file (00000.mpls) 72 contained in the aforementioned binding unit [symbol] must consider that the above-mentioned index file (index.bdmv) 82 and the playlist file (00000.mpls) 72 substitute for the index file (index.bdmv) 81 and the playlist file (00000.mpls) 71 contained in the disc package [symbol] , and must pre-manufacture the above-mentioned files in the form of finished files (i.e., complete files), such that the external CP can pre-provide the completely-shaped index file (index.bdmv) 82 and the completely-shaped playlist file (00000.bdmv) 72.

However, provided that the external CP does not provide the completely-shaped index file (index.bdmv) 82 and the completely-shaped playlist file (00000.bdmv) 72, the virtual package 51 must perform a composite operation in association with the index file (index.bdmv) 81 and the playlist file 71 (00000.mpls) 71 contained in the disc package [symbol] , such that it can form a new index file (index.bdmv) (not shown) and a new playlist file (00000.mpls) (not shown) using the aforementioned composite operation.

The second feature of the binding operation is as follows. If names of files contained in the disc package [symbol] are different from those of files contained in the binding unit [symbol] , the files contained in the binding unit [symbol] are appended or added to the virtual package. For example, as shown in FIG. 7, the “02000.clpi” file and the “02000.m2ts” file contained in the disc ID_{—}1 directory 63, and the “00001.mpls” file, the “03000.clpi” file, and the “03000.m2ts” file contained in the second shared directory 63a are indicative of newly added files having file names different from names of files contained in the disc package [symbol] , such that the new virtual package 51 is configured, by the addition of the above-mentioned files.

The third feature of the binding operation is as follows. If the same file names are present as the same binding unit [symbol] in the disc ID_{—}1 directory 63 and the second shared directory 63a, files contained in the disc ID_{—}1 directory 63 are firstly used. In other words, the priority order of files formed in the virtual package 51 is determined to be the order of the disc ID_{—}1 directory 63→the second shared directory 63a→the disc package [symbol] .

Therefore, provided that the “00002.mpls” file is present in the disc ID_{—}1 directory 63 and the second shared directory 63a (not shown), a file contained in the new virtual package will be replaced with the aforementioned “00002.mpls” file contained in the disc ID_{—}1 directory 63. In this way, provided that the “00003.mpls” file is present in the second shared directory 63a (not shown), a file contained in the new virtual package 51 will be replaced with the “00003.mpls” file contained in the disc ID_{—}1 directory 63. Therefore, the virtual package 51 is formed by the above-mentioned first to third features, such that original data recorded in the disc and additional data recorded in the local storage 15 can be reproduced at the same time using the aforementioned virtual package 51.

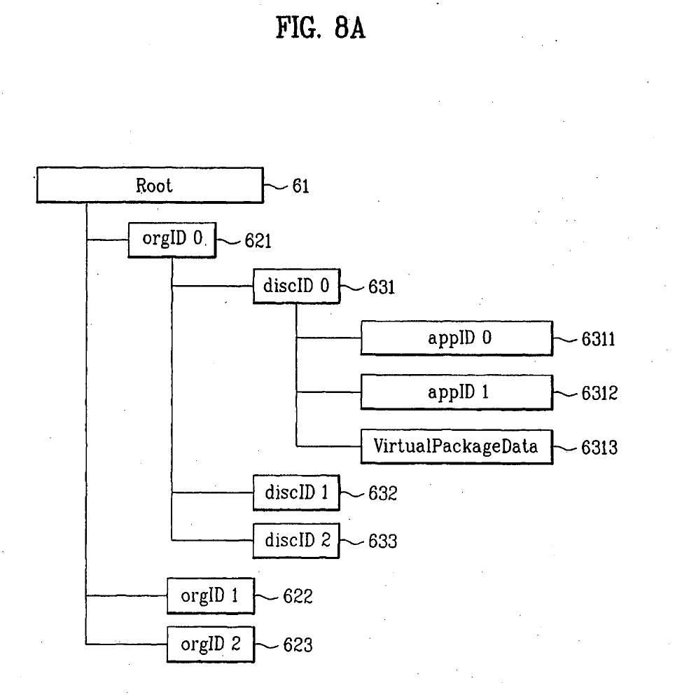

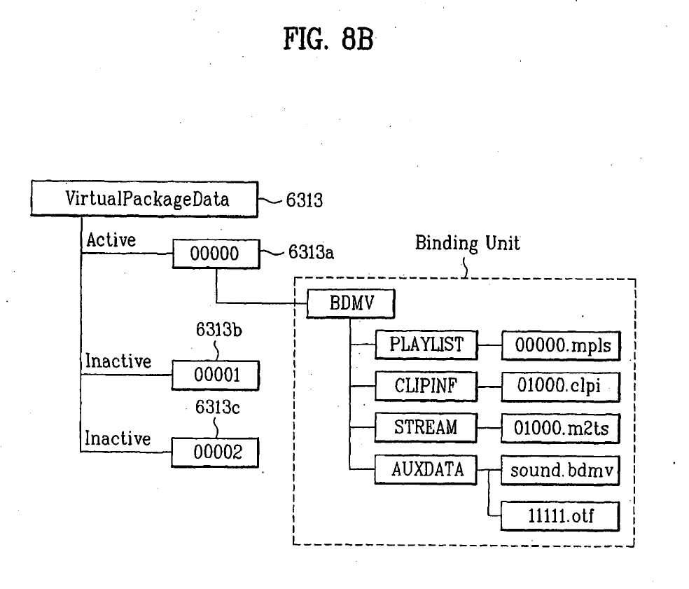

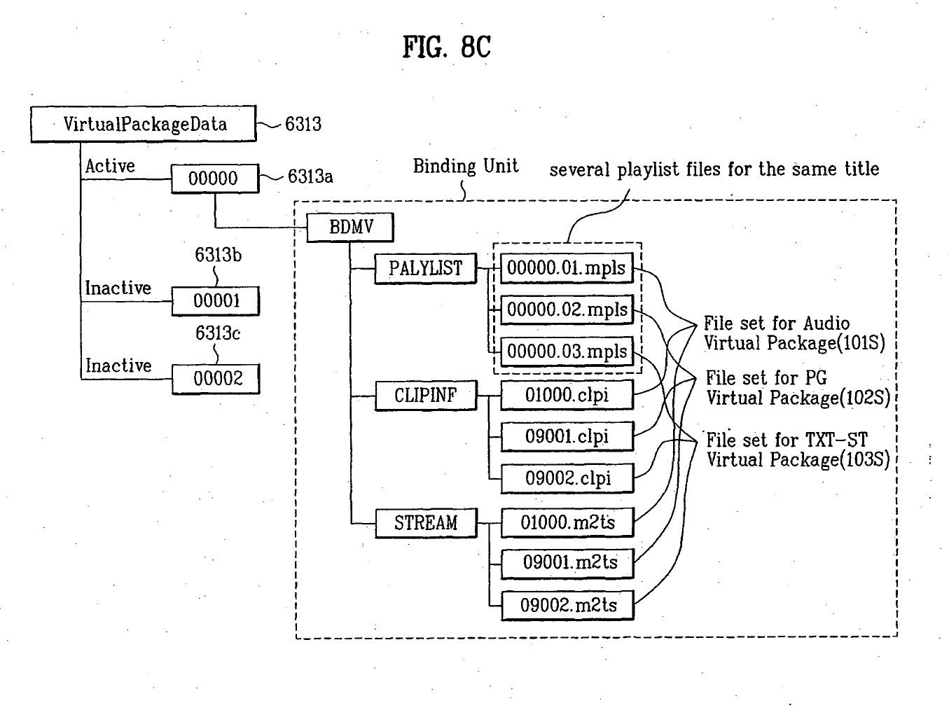

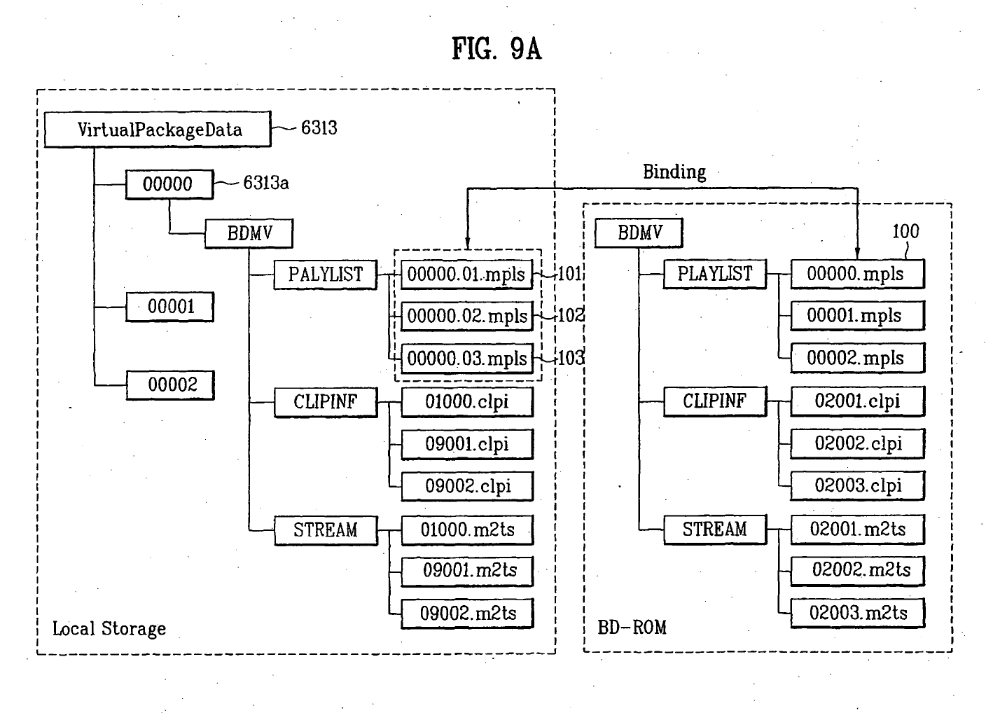

FIGS. 8a˜8c are conceptual file structures for use in a local storage file system in accordance with other preferred embodiments of the present invention.

FIG. 8a shows detailed structures of the disc ID directories 631, 632, and 633. Specifically, as can be seen from FIG. 8, the application directories 6311 and 6312 contained in the disc ID directories 631, 632, and 633 are separated from the application directories 6311 and 6312 and the virtual package data directory 6313. For example, the disc ID_{—}0 directory 631, the disc ID_{—}1 directory 632, and the disc ID_{—}2 directory 633 are positioned under the org ID_{—}0 directory 621. The disc ID_{—}0 directory 631 includes application directories 6311 and 6312 and a virtual package data directory 6313. In this case, each of the application directories 6311 and 6312 includes an application file or program controlled by only a disc having a specific. ID of “disc ID_{—}0”. The virtual package data directory 6313 is combined with a specific disc of “disc ID_{—}0”, and includes files to be contained in the virtual package.

FIGS. 8B˜8C show detailed structures of the virtual package data directory 6313. In association with the above-mentioned description, the preferred embodiment of FIGS. 8B˜8C is characterized in that the active directory (Active) and the inactive directory (Inactive) are used in FIGS. 8B˜8C.

In this case, the active (Active) directory is indicative of a directory composed of files of a current virtual package, and also indicates that all files contained in the active (Inactive) directory are used for the binding operation.

Preferably, the active (Active) directory may be controlled by only a Java system (e.g., BD-J application), files contained in the active (Active) directory may be only reproduced after being accessed, and an edition operation such as file deletion may not be allowed.

The inactive (Inactive) directory is indicative of a directory composed of one or more files incapable of forming a current virtual package. Therefore, the inactive (Inactive) directory is controlled by the Java system (e.g., BD-J application), and files contained in the inactive (Inactive) directory are accessed, such that an edition operation such as file deletion is allowed.

In association with the above-mentioned description, a single virtual package data directory 6313 may include a single active (Active) directory 6313a and a plurality of inactive directories 6313b and 6313c. In other words, a single active directory must be present as a directory used for a current binding operation in the virtual package data directory. Also, at least one inactive directory may also be present as a directory unused for the current binding operation in the virtual package data directory as necessary. Also, the inactive (Inactive) directory may be changed to the active (Active) directory, and the active (Active) directory may also be changed to the inactive (Inactive) directory.

However, for another example, a plurality of active (Active) directories may be present in the virtual package data directory. In this case, a high-level control program for controlling the binding operation may be required.

The directories (00000, 00001, and 00002) contained in the virtual package data directory 6313 may serve as directories capable of storing files classified according to downloaded content data. In other words, a plurality of content data units contained in a single title may be separated from each other as necessary. For example, a single title includes an audio stream and a graphic stream. The audio stream is stored in the inactive directory (00001), and the graphic stream is stored in the inactive directory (00002).

Therefore, the separated/stored content data moves to the active (Active) directory prior to the binding operation.

FIG. 8B shows an example in which a single active directory (00000) and a plurality of inactive directories (00001, 00002) are contained in the virtual package data directory 6313. The binding unit for forming the virtual package is present in the active directory (00000). Although files contained in the inactive directories (00001, 00002) are shown in FIG. 8B, all files contained in the binding unit of the active directory (00000) may be present in the structure of FIG. 8B.

FIG. 8C shows another example of a binding unit capable of forming the virtual package in the active directory (0000). In other words, a plurality of content data units contained in a single title are configured in the set of additional files. For example, the first set (101S) of audio files (00000.01.mpls, 01000.clpi, and 01000.m2ts), the second set (102S) of presentation graphic (PG) files (00000.02.mpls, 09001.clpi, and 09001.m2ts), and the third set (103S) of text subtitle (TXT-ST) files (00000.03.mpls, 09002.clpi, and 09002.m2ts) can be configured separately from each other. In the case of the above-mentioned example, the first file set 101S, the second file set 102S, and the third file set 103S are downloaded while being classified according to content units, are stored as individual files in the inactive directory, and move to the active directory prior to the binding operation, such that a single binding unit is formed.

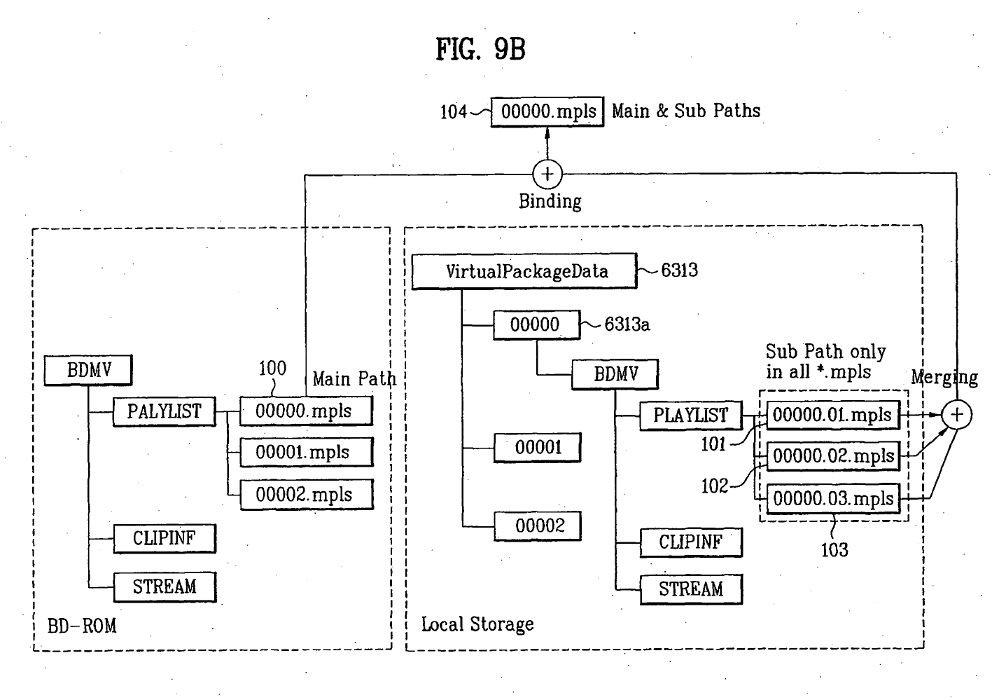

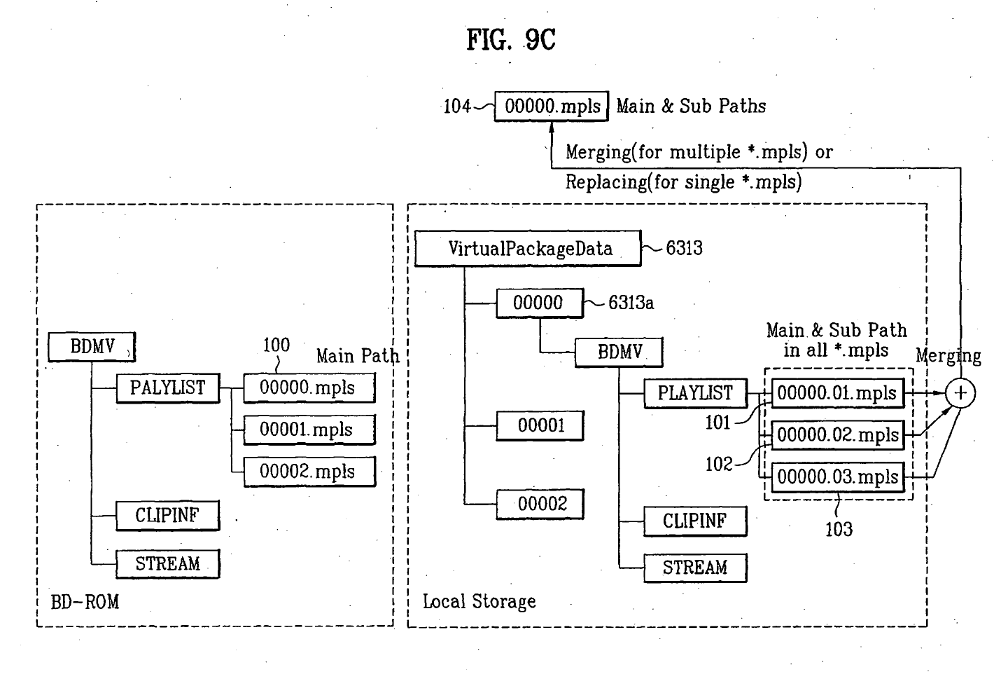

FIGS. 9A˜9C are conceptual diagrams illustrating methods for forming another virtual package according to the present invention. For example, a binding method for use in the binding unit of FIG. 8C is shown in FIGS. 9A˜9C.

FIG. 9A shows a binding operation by which a single playlist file (00000.mpls) 100 contained in the disc may be combined with a plurality of playlist files 101, 102, and 103 contained in the binding unit. It can be noted that a plurality of playlist files 101, 102, and 103 contained in the binding unit are equal to playlist files of individual contents associated with the playlist file 100 contained in the disc.

FIG. 9B shows a detailed binding operation of the process shown in FIG. 9B.

In association with the above-mentioned description, FIG. 9B shows an example in which the playlist file 100 of the disc configures a main path, and a plurality of playlist files 101, 102, and 103 contained in the binding unit configure sub-paths, respectively.

Firstly, a plurality of playlist files 101, 102, and 103 contained in the binding unit are merged to form at least one sub-path, and the sub-path is combined with the playlist file 100 contained in the disc, such that a virtual playlist file contained in the virtual package is formed. In this case, a single sub-path may be formed, or a plurality of sub-paths classified according to individual playlist files 101, 102, and 103 may also be formed.

In association with the above-mentioned description, FIG. 9C shows an example in which the playlist file 100 contained in the disc configures a main-path, and each of the playlist files 101, 102, and 103 contained in the binding unit includes the main-path and the sub-path.

In this case, the virtual playlist file 104 contained in the virtual package is formed by merging the playlist files 101, 102, and 103 contained in the binding unit, and is not merged with the playlist file 100 contained in the disc. FIG. 9C shows an example in which each of the playlist files 101, 102, and 103 contained in the binding unit include the main path, such that content data of the playlist file 100 contained in the disc is pre-contained in FIG. 9C.

In association with the above-mentioned description, provided that only a single playlist file 101, 102, or 103 is present in the binding unit, a corresponding playlist file may be replaced with a virtual playlist file 104.

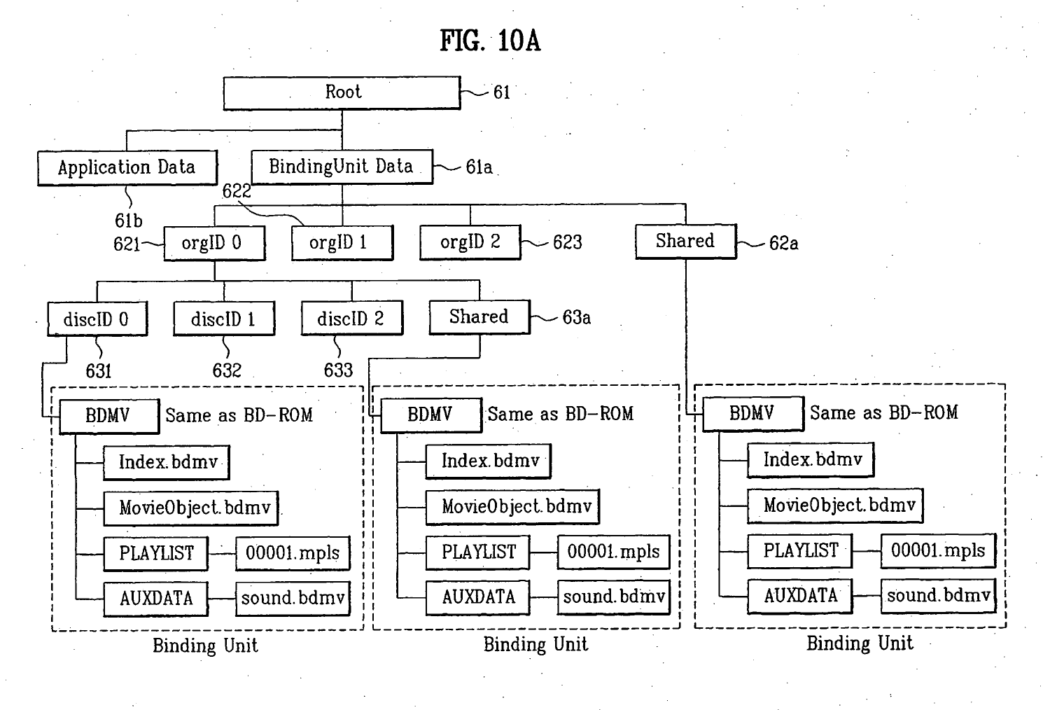

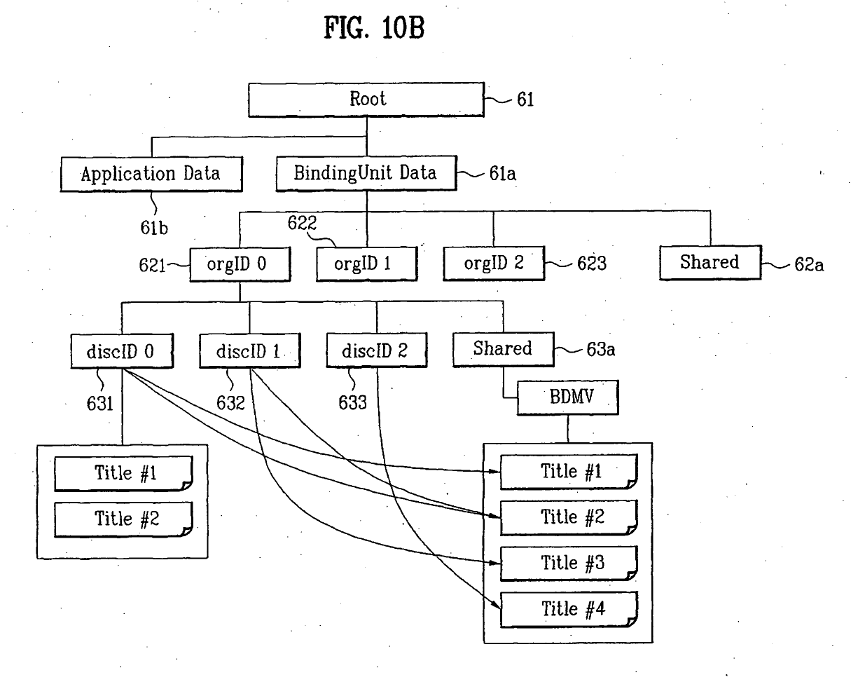

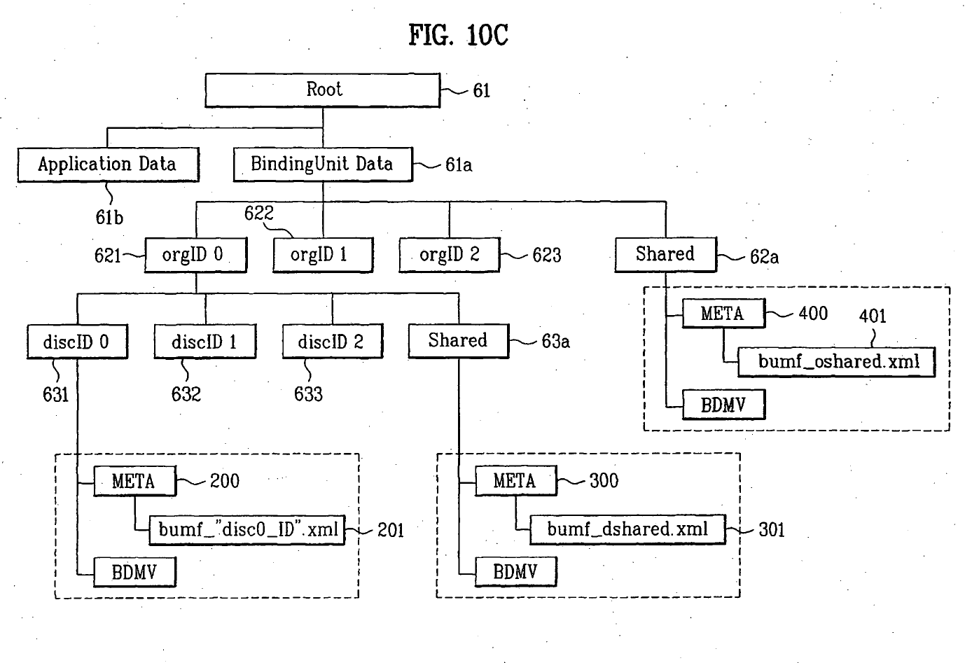

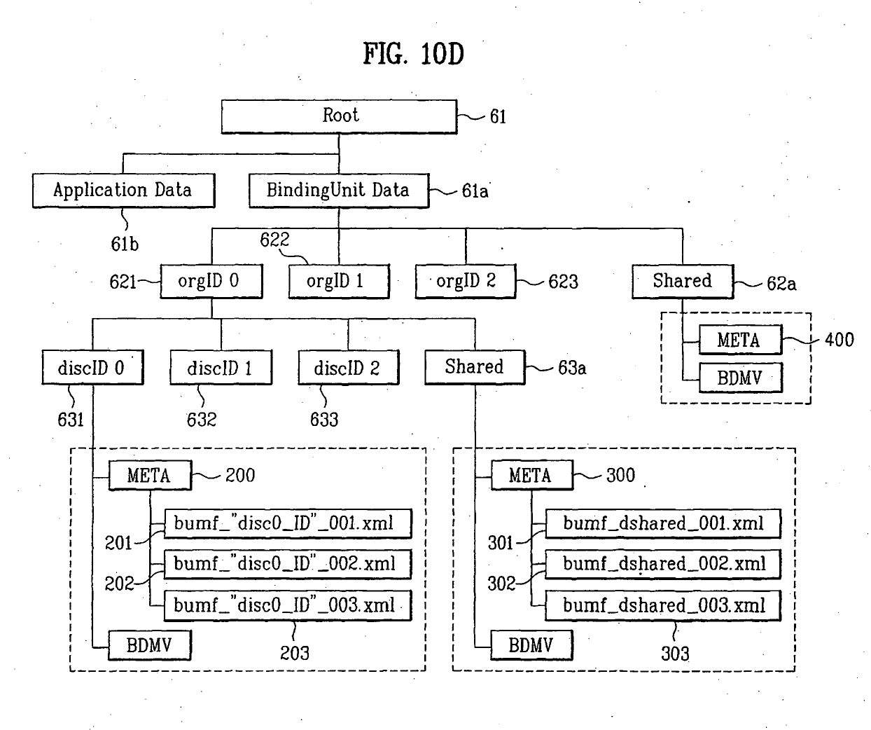

FIGS. 10A˜10D are conceptual file structures for use in a local storage file system in accordance with still other preferred embodiments of the present invention. Specifically, structures of FIGS. 10A˜10D are depicted on the basis of the shared directory.

The first shared directory 62a for allowing the org ID directories 621, 622, and 623 to share common file information, and the second shared directory 63a for allowing the disc ID directories 631, 632, and 633 to share common file information are depicted in FIG. 10A, in the same manner as in the preferred embodiment of FIG. 6D.

Also, individual directories are managed by a resident application acting as a system program. In other words, the resident application contained in the optical recording/reproducing device edits files of a specific directory contained in the local storage, or controls a binding operation of the files of the specific directory.

In association with the above-mentioned description, according to the preferred embodiment of FIG. 10A, the first shared directory 62a, the disc ID directories 631˜633, and the binding unit of the second shared directory 63a are configured to have the same format.

In association with the above-mentioned description, files contained in the first shared directory 62a and files contained in the second shared directory 63a will hereinafter be described.

Firstly, it should be noted that the number of types of files contained in the first shared directory 62a be limited because copyright infringement may occur in the org ID directories 621˜623 formed by different content providers (CPs). Therefore, it is preferable that the first shared directory 62a is composed of a minimum of files having no copyright infringement problems.

File types contained in the second shared directory 63a may be available in various ways, because the disc ID directories 631˜633 formed by a single CP may have less probability of generating the above-mentioned copyright infringement problem. For example, a common click-sound file may be provided as auxiliary data, or a new movie trailer title may also be provided as such auxiliary data as necessary. However, it should be noted that a database file or content file associated with a specific disc is not contained in the second shared directory 63a. Preferably, the priority order of binding operations of the above-mentioned binding units may be determined to be the order of the disc ID directory 63→the second shared directory 63a→the first shared directory 62a.

FIG. 10B exemplarily shows a title structure of the second shared directory 63a. In other words, the preferred embodiment of FIG. 10B is designed to consider that files are edited in title units.

Therefore, provided that a specific title (e.g., Title #1) contained in the second shared directory 63a is association with only a specific disc ID directory 631, and is not associated with other disc ID directories 632 and 633, the file edition may be independently performed.

However, if a specific title (e.g., Title #2) contained in the second shared directory 63a is associated with a plurality of disc ID directories 631 and 632, it is difficult to perform the aforementioned independent file edition. In this case, all disc ID directories 631 and 632 associated with a corresponding title must be edited at the same time.

For another example, a system for preventing the file edition when the optical recording/reproducing device is manufactured may be designed. Also, another system which prevents files from being deleted whereas it performs the addition of files may also be designed. In this way, a variety of systems may be designed according to their unique applications.

FIGS. 10C˜10D show various preferred embodiments of the file structure contained in the local storage file system according to the present invention. Specifically, the file structure for constructing the binding information in the binding unit is shown in FIGS. 10C˜10D.

The binding information is indicative of specific information capable of determining the binding operation. The preferred embodiment of FIGS. 10C˜10D is characterized in that it includes an additional directory and an additional file structure for use in the binding information.

For example, the binding unit includes a metadata directory (META), and the metadata directory (META) includes a file equipped with the binding information.

According to the preferred embodiment of FIGS. 10C˜10D, the aforementioned file equipped with the binding information is referred to as a manifest file, and may be referred to as one of the “bumf_disc0_ID.xml” file 201, the “bumf_dshared.xml” file 202, and the “bumf_oshared.xml” file 203, etc. according to upper binding unit categories. It is obvious to those skilled in the art that the metadata directory (META) may further include a variety of metadata files other than the aforementioned manifest files as necessary.

The aforementioned manifest file includes a variety of binding information units.

In other words, the manifest file may designate a binding object file, and may determine content data of the binding operation as necessary. Also, the manifest file can record a download time and an update time of a specific file, and may also include specific information indicating whether the specific file corresponds to a file edition object.

In association with the above-mentioned description, FIG. 10C shows an example in which a single manifest file is formed in individual discs, and FIG. 10D shows another example in which the manifest file is formed in individual titles contained in the disc.

For example, three titles contained in the binding unit of the disc ID directory 631 may have the “bumf_disc0_ID_{—}001.xml” file 201, the “bumf_disc0_ID 002.xml” file 202, and the “bumf_disc0_ID_{—}003.xml” file 203, respectively. In this way, individual titles of the second shared directory 63a may also have the “bumf_dshared_{—}001.xml” file 301, the “bumf_dshared_{—}002.xml” file 302, and the “bumf_dshared_{—}003.xml” file 303, respectively. When constructing the manifest files of individual titles as described above, the binding- and edition-operations of individual titles can more effectively performed.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention provides a method and apparatus for reproducing data from a recording medium using a local storage, a method for forming a virtual package, such that they can effectively reproduce original data recorded in the recording medium and additional data stored in the local storage, resulting in the creation of more convenient functions for a user.

1. A method for reproducing data of a recording medium using a local storage comprising the steps of:
a) reading a binding unit contained in a directory associated with a recording medium from a file structure contained in the local storage;
b) performing a binding operation for combining the read binding unit with the file structure contained in the recording medium, and forming a virtual package; and
c) reproducing data stored in the recording medium and/or data stored in the local storage using the formed virtual package.

2. The method according to claim 1, wherein the data stored in the local storage includes data downloaded from a content provider (CP).

3. The method according to claim 1, wherein the file structure contained in the local storage includes one or more disc identification (ID) directories classified according to individual recording mediums.

4. The method according to claim 3, wherein the file structure contained in the local storage further includes one or more org ID directories classified according to individual content providers, such that the org ID directory acts as an upper directory of the disc ID directory.

5. The method according to claim 3, wherein the file structure contained in the local storage further includes one or more content ID directories classified according to individual contents, such that the content ID directory acts as a lower directory of the disc ID directory.

6. The method according to claim 5, wherein the content ID directory for each content is formed whenever content data is downloaded from the content provider and is then stored in the local storage.

7. The method according to claim 4, wherein the file structure contained in the local storage further includes at least one shared directory having a binding unit commonly combined with all recording mediums manufactured by the same content provider, such that the shared directory acts as a lower directory of the org ID directory.

8. The method according to claim 4, wherein the file structure contained in the local storage further includes a shared directory having a binding unit commonly combined with all recording mediums irrespective of content providers, such that the shared directory acts as an upper directory of the disc ID directory.

9. The method according to claim 1, wherein the file structure contained in the local storage includes a single directory for each recording medium.

10. The method according to claim 8, wherein the single directory for each recording medium is indicative of a disc content ID (Disc_Content ID) directory.

11. The method according to claim 8, wherein the single directory for each recording medium is indicative of an org disc content ID (Org_Disc_Content_ID) directory.

12. The method according to claim 1, further comprising the step of:
if the read binding unit includes a file having the same name as that of a file contained in the recording medium file structure, replacing a file contained in the virtual package with the file contained in the binding unit.

13. The method according to claim 1, further comprising the step of:
if the read binding unit includes a file having a name different from that of a file contained in the recording medium file structure, adding or appending the file contained in the binding unit to the virtual package.

14. The method according to claim 7, further comprising the step of:
reading the binding unit of the disc ID directory and the binding unit of the shared directory.

15. The method according to claim 14, further comprising the step of:
if a file contained in the binding unit read from the disc ID directory has the same name as that of a file contained in the binding unit read from the shared directory, forming the virtual package using the file contained in the disc ID directory.

16. An apparatus for reproducing data of a recording medium using a local storage comprising:
a pickup unit for reading original data from a recording medium;
a local storage for storing additional data associated with the original data, and including a file structure for managing the additional data, such that the file structure includes at least one directory for identifying individual recording mediums; and
a controller for forming a virtual file system to simultaneously reproduce the original data and/or the additional data, and forming a virtual package capable of reproducing the original data and the additional data using the virtual file system.

17. The apparatus according to claim 16, wherein the controller reads a binding unit contained in a directory associated with the recording medium from a file structure contained in the local storage, and performs a binding operation for combining the read binding unit with the file structure contained in the recording medium, such that it forms the virtual package.

18. A method for constructing a local storage file system comprising the steps of:
a) allowing an org identification (ID) directory for each content provider to have at least one disc ID directory and a single shared directory;
b) allowing each disc identification (ID) directory to have a first binding unit combined with only a corresponding recording medium (i.e., a disc); and
c) allowing the single shared directory to have a second binding unit combined with all recording mediums (i.e., discs) provided from the content provider.

19. The method according to claim 18, wherein the first binding unit includes a file equipped with binding information (i.e., a binding information file).

20. The method according to claim 19, wherein the first binding unit further includes a metadata directory (META) having the binding information file.

21. The method according to claim 20, wherein the metadata directory (META) includes a single binding information file.

22. The method according to claim 20, wherein:
the binding information file includes a plurality of binding information files of individual titles contained in the metadata directory (META).

23. The method according to claim 18, wherein the second binding unit includes a file equipped with binding information (i.e., a binding information file).

24. The method according to claim 18, further comprising the step of:
including another shared directory in the org ID directory for each content provider.

25. A method for forming a virtual package comprising the steps of:
a) reading a file structure contained in a recording medium (i.e., a disc package) capable of reproducing original data recorded in the recording medium;
b) reading a binding unit which is associated with the recording medium from a directory having the same identification (ID) information as that of the recording medium of a local storage file structure; and
c) combining the read binding unit with the disc package, and forming a virtual package capable of reproducing original data contained in the recording medium and/or additional data contained in the local storage.

26. A method for forming a virtual package comprising the steps of:
a) reading an original file for reproducing original data contained in a recording medium, and reading an additional file contained in a local storage;
b) if the original file has the same name as that of the additional file, replacing the original file with the additional file; and
c) if the original file has a name different from that of the additional file, adding or appending the additional file, and forming the virtual package.

27. A method for constructing a local storage file system comprising the steps of:
a) allowing an org identification (ID) directory for each content provider to include at least one disc ID directory; and
b) allowing the disc identification (ID) directory to include a first directory which has an active directory (Active) capable of constructing a current binding unit and an inactive directory (Inactive) incapable of the current binding unit.

28. The method according to claim 27, wherein the first directory includes a single active directory.

29. The method according to claim 27, wherein:
a plurality of active directories are present in the first directory.

30. The method according to claim 27, wherein the inactive directory can be changed to the active directory.

31. The method according to claim 27, wherein the disc ID directory further includes at least one second directory which has an application program file controlled by only a corresponding recording medium.

32. The method according to claim 27, wherein the org ID directory for each content provider includes a single shared directory commonly applied to at least one disc ID directory.
